(19) United States
(12) Patent Application Publication
(10) Pub. No.: US 2024/0168662 A1
(43) Pub. Date: May 23, 2024

(54) COMPUTER-IMPLEMENTED METHOD FOR THE EFFICIENT GENERATION OF A LARGE VOLUME OF CONFIGURATION DATA

(71) Applicant: Christoph SCHNEIDER, Petersburg (DE)

(72) Inventor: Christoph SCHNEIDER, Petersburg (DE)

(21) Appl. No.: 18/399,860

(22) Filed: Dec. 29, 2023

Related U.S. Application Data
(63) Continuation of application No. PCT/EP2022/067667, filed on Jun. 28, 2022.

(30) Foreign Application Priority Data
Jul. 2, 2021 (EP) 21020342.8

(51) Int. Cl. G06F 3/06

(52) U.S. Cl. CPC G06F 3/0629; G06F 3/067; G06F 3/0604

(57) ABSTRACT

A method for processing large amounts of data, so-called big data, using different computing architectures and arithmetic is provided. Distributed and heterogeneous data sources may be used. Also provided is a system arrangement and set up accordingly. Furthermore, a computer program product with control instructions is proposed, which implement the proposed method or operate the proposed device and arrangement.

### CROSS REFERENCE TO RELATED APPLICATIONS

This application is a continuation of International Application No. PCT/EP2022/067667, filed on Jun. 28, 2022, which takes priority from European Patent Application No. 21020342.8, filed Jul. 2, 2021, the contents of each of which are incorporated by reference herein.

### TECHNICAL FIELD

The present invention relates to a method for processing large amounts of data, so-called big data, using different computing architectures and arithmetic. Distributed and heterogeneous data sources may be used. The invention is further directed toward a system arrangement which is set up accordingly. Furthermore, a computer program product with control instructions is proposed, which implements the proposed method or operates the proposed device and arrangement.

### BACKGROUND

U.S. Pat. No. 8,566,279 B1 shows a system that compares configuration data but does not use matrices.

US 2019/0095494 A1 shows a system and method for processing and executing queries relating to one or more data sets. In addition, multiple partitioning of data is proposed.

EP 3 764 618 A1 shows a method for the efficient optimization of memory allocation, which makes it possible for resources available in a computer network to be used efficiently and the required bandwidth to be optimized in the process. In addition, the invention makes it possible for the data to be anonymized or implicitly encrypted by segmentation during swapping.

Various processing techniques are shown in the prior art which make it possible to recognize structures in extensive data sets, so-called big data, and to process the data accordingly. One challenge here is the different data types in the raw data, which create issues in data compatibility and processing.

The proposed methods are very research intensive, which is a problem especially for large data sets. Processors typically have multiple cores, but this often results in time-consuming computations and there are processor architectures that cannot process certain types of matrices efficiently enough with the instruction sets provided for some applications. This particular problem arises when extensive matrices are provided, which are stored and distributed in a network. This requires a large number of buffers in order to be able to process the matrices efficiently in certain application scenarios. In summary, it can be concluded that certain computer architectures are not optimized for matrices.

In addition, in some processor types instruction sets are fixed, i.e. hard-coded, and consequently it is not possible with such processors to generate dynamic calculation steps in such a way that these can be applied according to the configuration data. In addition, it is not possible to provide optimized calculation steps, but rather an existing instruction set must be used, even if this is not optimized for certain input data.

In general, there is also the problem that processing large data sets, so-called big data, is often error-intensive and requires large hardware capacities. Errors can result from the fact that a certain floating point arithmetic causes errors or that data types are not compatible with each other. It is possible, for example, that decimal places in a first data type are calculated with fewer bits than in a second data type. This will inevitably lead to an error, which causes further miscalculations.

An object of the proposed invention is to provide an improved method which is suitable for the efficient generation of extensive configuration data and addresses the problems mentioned. Also proposed is a corresponding system arrangement which can be implemented or operated according to the method. In addition, a computer program product is to be provided which contains control commands that implement the method or operate the proposed device.

### SUMMARY

The object may be solved by a method with the features described herein.

Accordingly, a computer-implemented method is proposed for efficiently generating large-scale configuration data based on heterogeneous data sources. This comprises reading a stored array of configuration data and serializing the read configuration data according to a first serialization metric; reading at least one other stored array of configuration data and serializing the read configuration data according to a second serialization metric; wherein a serialization metric is provided for each matrix, which provides an indication of how data records of the matrix are read out and in which order the configuration data are written in series and all provided serialization metrics generate comparable vectors of the same length in such a way that the shorter vector is filled with fill data; calculating a relation between the serialized configuration data; and creating new configuration data in response to the calculated relation.

A method for the efficient generation of extensive configuration data is proposed, whereby the configuration data is generally stored according to some data type. As data types are not always compatible, it may be necessary to introduce further processing steps for this purpose. Embodiments of the present invention imply that data types are either converted or the calculation of a relation between the serialized configuration data is performed in such a way that only certain configuration data is set in relation. In this context, the configuration data assumes that the pairwise configuration data that are compared, are of a compatible data type. If more than two matrices are present which can not be compared evenly in pairs, the configuration data of several matrices can be used.

It is also possible not to generate a relation between all configuration data, but rather to first check whether a relation can be generated by the fact that compatible data types are present. If, for example, the algorithm meets the configuration data from a first matrix, which have no correspondence in the configuration data from the second matrix, then, accordingly, no relation is produced. Therefore, a selection of the configuration data takes place for the generation of a relation.

In each case, the stored matrices can be transferred into a vector, whereby the vector stores the configuration data of the matrix serially. If at least two vectors are compared with one another or set in relation, then in each case the entry within the vector can be compared with a further entry of a further vector, whereby in each case the appropriate index is considered. If, for example, the configuration data is written in a first column and the configuration data of a further matrix are written in a second column, the data can also be compared line by line. If there is no correspondence in the second row to the entry from the first row, no relation is calculated. The way the vectors or columns are calculated is stored in the serialization metric.

The serialization metric determines how each matrix is to be serialized. For example, a matrix can be read row by row and the individual entries can be written into a vector. Therefore, it is generally possible to transfer the matrix from a two-dimensional table into a one-dimensional column.

Embodiments of the present invention also consider multidimensional matrices and the serialization metric specifies how these data entries are written into a vector. In general, it is not only possible to transform a matrix into one vector, but also to generate several vectors. If necessary, these can also have redundant data records.

The matrices are typically read out via a network together with the stored configuration data. For this purpose, the matrices are stored on a server and the data sources are typically heterogeneous. In this sense, heterogeneous refers to the data types and the underlying hardware. Therefore, it is possible that the data sources can be provided by different operating systems. Furthermore, the processing steps can be distributed in the network in such a way that a readout takes place on a first computing unit and then a transfer of the configuration data takes place to a second computing unit, where it is then serialized, i.e. stored serially. In addition, it is advantageous that the serialization takes place on the computing unit on which the matrix is stored. Furthermore, it is possible to send a serial data stream via the network.

In certain application scenarios, it can be advantageous to carry out a serial data transmission as this can often be carried out more easily compared to the transmission of a matrix. For example, all network components typically support serial data streams and corresponding protocols provide for appropriate security mechanisms. A checksum can be calculated via the serial data stream and the serial data stream corresponds to the actual real-world data transmission in that an analog signal is typically transmitted, which is then digitized using threshold values that relate to an amplitude in the analog signal.

In general, according to the proposed method, any number of matrices can be compared or related to each other. This requires at least two matrices, a first matrix and at least one further matrix are proposed.

A calculation of a relation between the serialized configuration data is a comparison according to predetermined process steps. It is possible to compare the configuration data in such a way that it can be determined, for example, which configuration data set is the largest. This configuration data can then be read. The production of new configuration data occurs by copying the previously read and serialized configuration data. This can also be done by means of a reference to the stored configuration data. According to embodiments of the invention, it is possible to compare, for example, two vectors to see the larger value as new configuration data. It is also possible to compare the first vector with the second, or any further, vector and then to determine which vector satisfies a specific relation. It can be concluded that when the configuration data is numeric on the basis of a “larger” relation, it can be determined which new configuration data will be produced. For this, data from both vectors can be combined and, for example, the larger value can be written into a new vector. It is also possible, for example, to calculate which configuration data is largest and based on that, create a new vector containing the largest entries.

If the configuration data is alphanumeric, then other rules can be determined which indicate how a relation is constructed. Terms can be set, for example, on the basis of taxonomy in which case the relation describes a relation of the configuration data within the underlying data structure. The relation can, for example, analyze several terms and then provide output based on a calculation of the highest prioritized configuration data and thus a vector with new configuration data is generated which evenly displays the configuration data with the highest priority.

In another example, if the date is numeric, the relation can calculate the difference between two configuration data sets. New configuration data can then be created in such a way that the difference between the data sets forms the configuration data or that dependence of the differences creates the configuration data within a relation vector.

One aspect of embodiments of the present invention is that the matrices are each stored on different storage devices and transmitted via network. This has the advantage that there is a high degree of reliability in the provision of the matrices, since they can be distributed over a network and, if necessary, can be stored redundantly. In addition, the proposed method is independent of the fact that the large and extensive data sets can be stored on a device. The proposed method is scaled due to the distribution in the network.

A further aspect of embodiments of the present invention is that the matrices have data sets of different data types and a calculation of a relation is always performed between data sets of the same data types. This has the advantage that heterogeneous data types can generally be used, whereby the proposed method checks whether a relation can be generated at all. Consequently, only those data sets are used which are compatible with each other. If a vector is generated, which describes the relations, then appropriate entries of non-compatible configuration data remain empty.

A further aspect of embodiments of the present invention is that a conversion of data types is performed. This has the advantage that further relations can be calculated even if the same data type is not present in each case. For example, it is possible to store a numeric value also as text or to store numeric values as data types with different numbers of bits. For example, floating point numbers can be stored as 32 bits or 64 bits. According to this aspect it is ensured that as many relations as possible can be calculated and, in this context, it is particularly advantageous that the data types are converted in such a way that they match.

A further aspect of embodiments of the present invention is that the configuration data is serialized into configuration vectors. This has the advantage that existing implementations can be reused and, in particular, storing within a vector is particularly efficient.

A further aspect of embodiments of the present invention is that a serialization metric is provided for each matrix which provides an indication of how records of the matrix are transformed. This has the advantage that for each matrix, it is known how it is read out at all times and in which order the configuration data is written.

A further aspect of embodiments of the present invention is that all serialization metrics provided generate comparable vectors. This has the advantage that as many relations as possible can be calculated. Thus, the vectors can be made comparable by creating an equal length in two vectors in case they contain different dimensions or number of entries in such a way that the shorter vector is filled up with fill data.

A further aspect of embodiments of the present invention is that all serialized configuration data, all relations and/or all new configuration data is stored in the same database. This has the advantage that there is no delay through a network for the computationally intensive operations, but rather the data is held locally and a common buffer memory can be used.

A further aspect of embodiments of the present invention is that the relation is generated iteratively for a selection of configuration data in each case. This has the advantage that the respective vectors or configuration data written serially are checked through and, in the event that a relation can be generated, a value from the configuration data from the first matrix and the second matrix is compared in pairs. If several matrices are present, the configuration data is compared according to the indexing. For example, if there are three vectors, the first entry is compared with any further first entries, the second entry is compared with any further second entries of the other vectors and a table can be compared line by line.

A further aspect of embodiments of the present invention is that data memory is provided by inputting calculation steps for calculating relations. This has the advantage that the relations in this data memory can be predetermined and can be adapted at any time. The calculation steps describe how a relation is to be generated. Calculation steps can be distinguished according to numeric or alphanumeric values. With numeric values the computation steps can describe an arithmetic, whereby with alphanumeric configuration data a prioritization can take place. Additionally, other calculation steps are also possible.

A further aspect of embodiments of the present invention is that creating new configuration data comprises applying the relation to configuration data, adopting existing configuration data, and/or reading out further configuration data. This has the advantage that the new configuration data can either be selected from the existing configuration data or can be calculated from the configuration data. For example, a relation can give information regarding which configuration data will be used.

A further aspect of embodiments of the present invention is that the configuration data is used to drive a terminal device. This has the advantage that the results of the proposed method can be fed back into a terminal device, and thus operating parameters of the terminal device can be influenced by the configuration data.

The task is solved by a system arrangement for the efficient generation of extensive configuration data based on heterogeneous data sources, comprised of a first interface unit set up for reading out a stored matrix with configuration data and a serialization unit set up for serializing the read-out configuration data according to a first serialization metric; at least one second interface unit arranged for reading out at least one further stored matrix with configuration data and a further serialization unit arranged for serializing the read-out configuration data in accordance with a second serialization metric; whereby a serialization metric is provided for each matrix, which provides an indication of how data records of the matrix are read out and in which order the configuration data is written in series and all serialization metrics provided generate comparable vectors of the same length in such a way that the shorter vector is filled with fill data; a computing unit arranged for calculating a relation between the serialized configuration data; and an output unit arranged for creating new configuration data as a function of the calculated relation.

The task is also solved by a computer program product with control instructions that implement the proposed method or operate the proposed device.

According to embodiments of the invention, it is particularly advantageous that the method can be used to operate the proposed devices and units. Furthermore, the proposed devices and units are suitable for carrying out the method according to embodiments of the invention. Thus, in each case the device implements structural features which are suitable for carrying out the corresponding method. Additionally, the structural features can also be designed as process steps. The proposed method also provides steps for implementing the function of the structural features. In addition, physical components can also be provided virtually or virtualized.

Further advantages, features and details of embodiments of the invention are apparent from the following description, in which aspects of embodiments of the invention are described in detail with reference to the drawings. In connection, the features mentioned in the claims and in the description are essential to embodiments of the invention, either individually or in any combination. Likewise, the features mentioned above and those further elaborated on herein may be used individually or in any combination. Functionally similar or identical parts or components are partially provided with the same reference signs. The terms “left”, “right”, “top” and “bottom” used in the description of the embodiments refer to the drawings in an orientation with figure designation or reference signs. The embodiments shown and described are used as examples for explaining the invention. The detailed description is to be interpreted by a person skilled in the art, therefore known circuits, structures and methods are not shown or explained in detail in the description in order not to complicate the understanding of the present description.

### BRIEF DESCRIPTION OF THE DRAWINGS

Shown in the figures:

FIG. 1 shows a schematic block diagram of the system arrangement for efficiently generating extensive configuration data based on heterogeneous data sources in accordance with an embodiment of the present invention;

FIG. 2 shows a serialization of the matrices into vectors to generate another vector in accordance with an embodiment of the present invention;

FIG. 3 shows a representation of the generated columns of serialized records; and

FIG. 4 shows a schematic flowchart of the computer-implemented method for efficiently generating extensive configuration data based on heterogeneous data sources.

### DETAILED DESCRIPTION

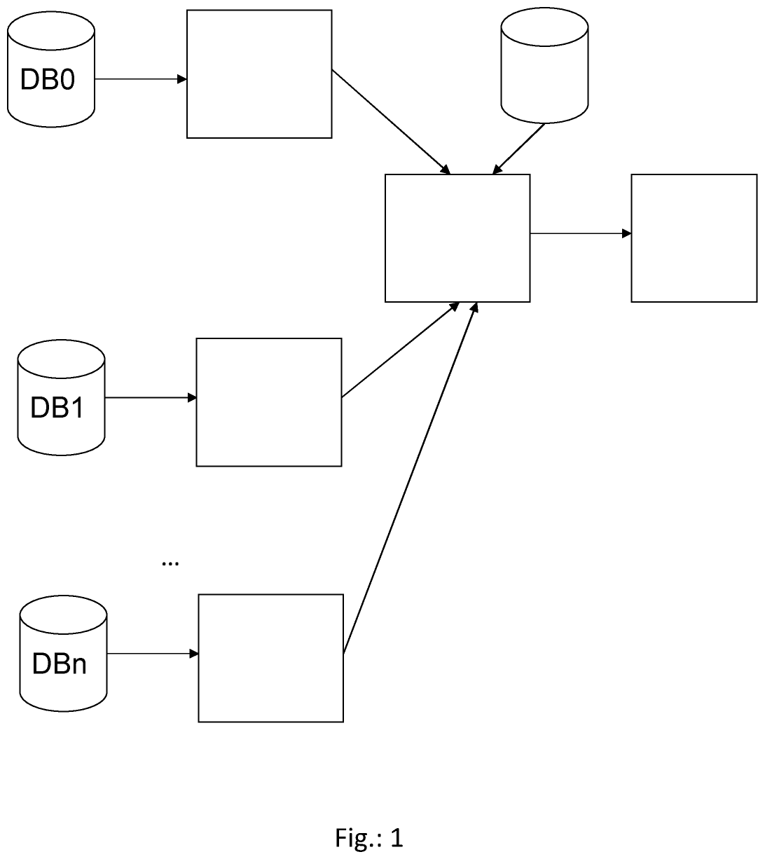

FIG. 1 shows a block diagram of the proposed system arrangement. At the top of FIG. 1 the processing of the first matrix is shown. This is provided by the first device and was shown as a database DB0. Thereupon, the provided matrix is serialized by the component connected to the right. In this component, for example, the matrix is read out line by line and then converted into a vector. This can be applied to a second matrix, as is shown below. This second matrix is shown as database DB1 and transmitted to the component connected on the right where the entirety of the configuration data is serialized. In the present FIG. 1 at the very bottom, it is shown that any number of matrices can be provided and serialized.

The configuration data written in series is then transmitted to a common component which calculates a relation. This component is also connected to a database, as shown, because the database holds corresponding calculation steps. Based on the output of this device, a new set of configuration data is created, which is performed in the rightmost component.

A computer-implemented method is proposed, although this does not prevent individual steps from being carried out manually. The configuration data can also indicate how, for example, an output device such as a printer or a display is addressed.

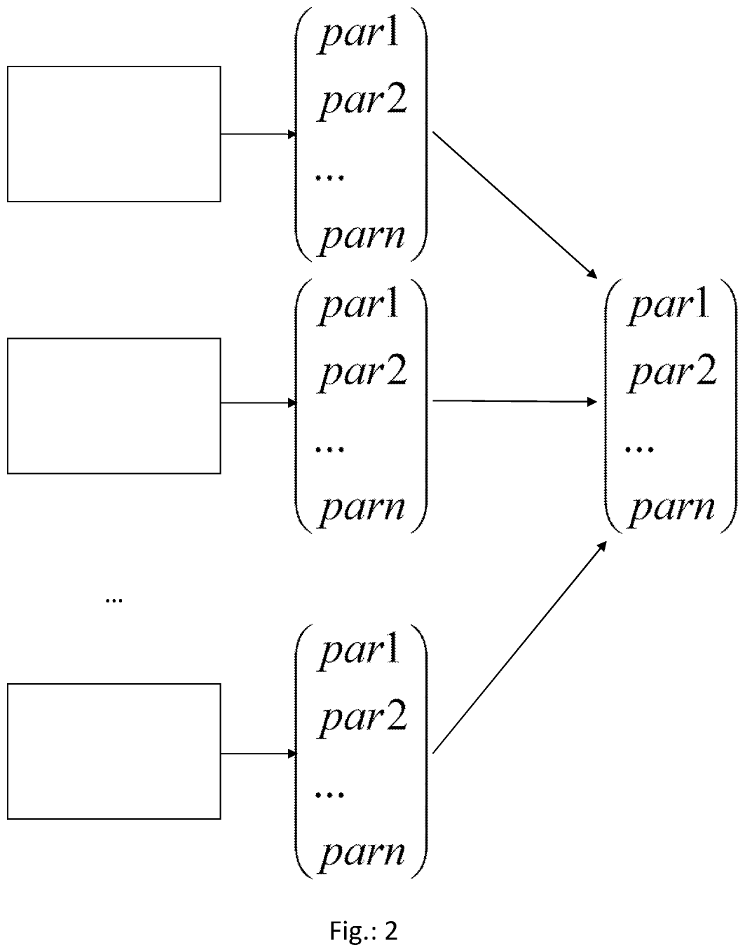

FIG. 2 shows how the data is used schematically. On the left side the raw data is drawn, which is stored as matrices. As detailed in the middle, these matrices are serialized and written into a vector. Subsequently, a relation is created and this relation is again stored in a vector. This is shown on the right side of the figure. Typically, the vector on the right side contains as many entries as the longest vector in the middle. However, it is also possible that only those relations are entered which can also be calculated into this vector. If the respective data type is not compatible to a data type to be compared even after a conversion, no relation can be generated and either an error code is entered at the corresponding position in the right vector or the data set is simply omitted. Therefore, the vector on the right side can be shorter than the vectors in the center.

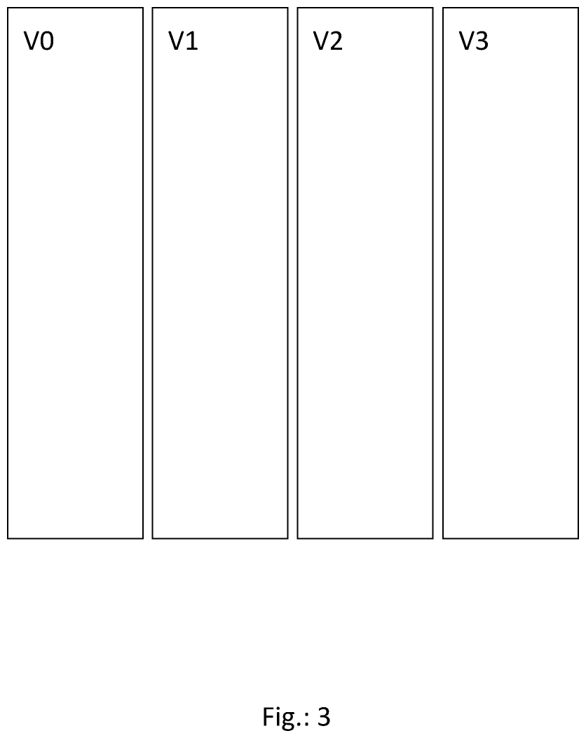

FIG. 3 shows a vector V0 on the left side, which was generated from a first matrix, which is now plotted as a column. Next to it a column V1 is drawn, which shows the configuration data of the further matrix. The third column V2 shows a relation between the configuration data. It is also possible to provide a fourth column V3, which shows the new configuration data. Consequently, one column is provided for each generated vector in the present example.

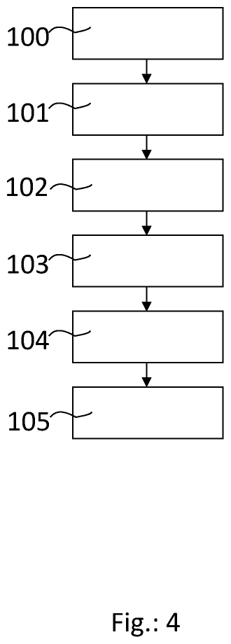

FIG. 4 illustrates a computer-implemented method for efficiently generating large-scale configuration data based on heterogeneous data sources, comprising: reading 100 a stored array of configuration data and serializing 101 the read configuration data according to a first serialization metric; reading 102 at least one other stored array of configuration data and serializing 103 the read configuration data according to a second serialization metric; whereby a serialization metric is provided for each matrix, which provides an indication of how data records of the matrix are read out and in which order the configuration data is written in series and all serialization metrics provided generate comparable vectors of the same length in such a way that the shorter vector is filled with fill data; calculating 104 a relation between the serialized configuration data; and creating 105 new configuration data as a function of the calculated relation.

Not shown here is a data storage or computer readable medium with a computer program product comprised of control instructions that implement the proposed method or operate the proposed system arrangement.

What is claimed is:

1. A computer-implemented method for efficiently generating large-scale configuration data based on heterogeneous data sources, comprising:
reading (100) a stored two-dimensional matrix with configuration data and serializing (101) the read configuration data according to a first serialization metric;
reading (102) of one further stored two-dimensional matrix with configuration data and serializing (103) the read configuration data according to a second serialization metric; whereby a serialization metric is provided for each matrix, which provides an indication of how data records of the matrix are read out and in which order the configuration data is written in series and all serialization metrics provided generate comparable vectors of the same length in such a way that the shorter vector is filled with fill data and the vectors are made comparable by converting data types of the configuration data or by calculating (104) a relation between the serialized configuration data in such a way that only pairs of configuration data which are of the same or compatible data type are compared;
calculating (104) a relation between the serialized configuration data; and
creating (105) new configuration data depending on the calculated relation, which comprises a reading of further configuration data.

2. The method of claim 1, wherein the matrices are each stored on different storage devices and are transmitted by network technology.

3. The method of claim 1, wherein the matrices have configuration data of different data types and a calculation (104) of a relation always takes place between configuration data of the same data types.

4. The method of claim 1, wherein a conversion of data types is performed.

5. The method of claim 1, wherein the configuration data is serialized into configuration vectors.

6. The method of claim 1, wherein all serialized configuration data, all relations and/or all new configuration data is stored in the same database.

7. The method of claim 1, wherein the relation is generated iteratively for a selection of configuration data in each case.

8. The method of claim 1, wherein a data memory with calculation steps for calculating relations is provided.

9. The method of claim 1, wherein the configuration data is used to control a terminal device.

10. A system arrangement for efficiently generating extensive configuration data based on heterogeneous data sources, comprising:
a first interface unit arranged for reading out (100) a stored two-dimensional matrix with configuration data, and a serialization unit arranged for serializing (101) the read-out configuration data according to a first serialization metric;
a second interface unit arranged for reading out (102) a further stored two-dimensional matrix with configuration data, and a further serialization unit arranged for serializing (103) the read-out configuration data according to a second serialization metric; whereby a serialization metric is provided for each matrix, which provides an indication of how data records of the matrix are read out and in which order the configuration data is written in series and all serialization metrics provided generate comparable vectors of the same length in such a way that the shorter vector is filled with fill data and the vectors are made comparable by converting data types of the configuration data or by calculating (104) a relation between the serialized configuration data in such a way that only pairs of configuration data which are of the same or compatible data type are compared;
a computing unit adapted to compute (104) a relation between the serialized configuration data; and
an output unit arranged to create (105) new configuration data in dependence on the calculated relation, which comprises reading out further configuration data

11. A computer program product comprising instructions which, when the program is executed by a computer, cause the computer to perform the steps of the method of claim 1

12. A computer-readable storage medium comprising instructions which, when executed by a computer, cause the computer to perform the steps of the method of claim 1.
